(19) United States
(12) Patent Application Publication
(10) Pub. No.: US 2008/0026746 A1
(43) Pub. Date: Jan. 31, 2008

(54) Modular Mobile Device

(76) Inventor: Anuradha K. Appaji, Plano, TX (US)

Correspondence Address: CONLEY ROSE, P.C., 5601 GRANITE PARKWAY, SUITE 750, PLANO, TX, 75024, US

(21) Appl. No.: 11/564,158

(22) Filed: Nov. 28, 2006

Related U.S. Application Data
(60) Provisional application No. 60/820,360, filed on Jul. 26, 2006.

(51) Int. Cl. H04Q 7/20

(52) U.S. Cl. 455/426.1

(57) ABSTRACT

A system for executing an application is provided. The system comprises a mobile device, a module, and a server. The module can store the application and is operable to be coupled to communicate to and decoupled from the mobile device. The server is operable to store the application and wirelessly communicate with the mobile device via a network and is operable to provide the mobile device access to the application on the server such that the mobile device is operable to access the application via the module when the module is coupled to communicate with the mobile device. When the mobile device is decoupled from the module, the mobile device is operable to access the application via the server.

### CROSS-REFERENCE TO RELATED APPLICATIONS

This application claims priority to U.S. Provisional Patent Application No. 60/820,360, entitled “Modular Mobile Device”, filed on Jul. 26, 2006, by Anuradha K. Appaji, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A traditional personal computer might store applications and data in a memory location, such as a hard drive, within the computer itself. When a user wishes to launch an application, the user might retrieve the application from the local storage location and cause the application to execute on the processor of the personal computer. Under a concept known as WebOS, a personal computer might be able to make use of applications that are stored remotely on a server computer. Such a personal computer might have a network connection to the server and a browser or similar graphical user interface that allows a user to interact with the server. When the user launches an application through the browser, the application might execute on the server rather than on the user's computer.

Data entered by the user into the browser might be sent over the network connection to the server for processing by the remote application. When the application completes the processing of the data, the server might send the browser a bitmap or other digital image depicting the appearance the browser should take on as a result of the processing of the data. That is, the browser is given the appearance it would have if the processing of the data had occurred on the user's computer rather than on the server. In this way, the user can be given the impression that the application is executing on the user's own computer.

The use of WebOS allows a personal computer with limited processing power and/or memory to behave in the manner of a more powerful computer. The low-end computer could appear to execute applications that it would otherwise be incapable of executing. The personal computer would not be tied to a particular operating system or set of locally installed proprietary applications but could instead use an open-source operating system and freely available browsers and web-based applications.

It should be understood that the term WebOS refers to one platform for accessing applications and data remotely over a network but that other platforms are available for performing similar functions. The terms “WebOS”, “WebOS-based”, and the like will be used hereinafter to refer to components and processes related to the execution of a remotely executed but locally manipulable application.

### SUMMARY

In one embodiment, a system for executing an application is provided. The system comprises a mobile device, a module, and a server. The module can store the application and is operable to be coupled to communicate to and decoupled from the mobile device. The server is operable to store the application and wirelessly communicate with the mobile device via a network and is operable to provide the mobile device access to the application on the server such that the mobile device is operable to access the application via the module when the module is coupled to communicate with the mobile device. When the mobile device is decoupled from the module, the mobile device is operable to access the application via the server.

In another embodiment, a method to promote execution of an application is provided. The method comprises coupling a removable module to a mobile device and using the mobile device to access a first instance of the application on the removable module. The method further comprises decoupling the removable module from the mobile device and using the mobile device to access a second instance of the application on a server so that the mobile device is used to locally manipulate the application and the application executing on the server.

In another embodiment, a mobile device for accessing an application is provided. The mobile device comprises an interface and a component. The interface is operable to couple the mobile device to a removable module. The removable module is operable to store the application and operable to be coupled to and decoupled from the mobile device. The component is operable to wirelessly connect the mobile device to a server via a network. The server is operable to provide access to the application by the mobile device such that the mobile device is operable to access the application via the removable module when the removable module is coupled to the mobile device. When the mobile device is decoupled from the removable module, the mobile device is operable to access the application via the server.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates a system for executing an application according to an embodiment of the disclosure.

FIG. 2 illustrates a mobile application server module according to an embodiment of the disclosure.

FIG. 3 illustrates a method for executing an application according to an embodiment of the disclosure.

FIG. 4 is a diagram of a wireless communications system including a mobile device operable for some of the various embodiments of the disclosure.

FIG. 5 is a block diagram of a mobile device operable for some of the various embodiments of the disclosure.

FIG. 6 is a diagram of a software environment that may be implemented on a mobile device operable for some of the various embodiments of the disclosure.

### DETAILED DESCRIPTION

It should be understood at the outset that although an illustrative implementation of one embodiment of the disclosure is illustrated below, the system may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents. This application is related to U.S. patent application Ser. No. ______ , entitled “Mobile Application Server Module”, filed on ______ , 2006, by Anuradha K. Appaji, which is incorporated herein by reference for all purposes.

The WebOS concept might be extended for use on handheld mobile electronic devices that have the capability for a wireless connection to the Internet or other networks. That is, devices such as mobile telephones, personal digital assistants, handheld computers, and similar devices might use a locally installed browser to wirelessly interface with a network and gain access to applications and data that are stored on a remote server. Such devices will be referred to herein as mobile devices. The use of WebOS can give a mobile device with limited resources access to applications that it would not be able to execute locally and can thus allow an inexpensive mobile device to have functionality that would otherwise be available only in more expensive mobile devices. Similarly, more expensive mobile devices can be given functionality that would otherwise require an infeasible amount of processing power and/or memory.

However, the use of WebOS on mobile devices might be limited by the fact that network connectivity for mobile devices can be unreliable. Multi-path fading in a radio frequency transmission, network perturbations, and other well-known wireless networking problems can cause a temporary loss of connection between a mobile device and a WebOS server. If a mobile device user is using an application that is executing on a WebOS server and the connection to the server is lost, the user could no longer send data to or receive data from the application and the functions available through the application would be lost until the network connection is restored. This can lead to a user experience that is less satisfactory than the use of a locally installed application.

In an embodiment, a removable module that can couple to a WebOS-based mobile device contains one or more applications that might also reside on a WebOS-based server. When the module is coupled to the mobile device, one or more of the applications might execute locally on the module and the module might provide the results of the execution of the application to the mobile device. This can provide faster and more reliable execution than would be the case if the application were to execute on the server. When the module is removed from the mobile device, applications can execute on the server in the standard manner for a WebOS environment. In this way, the mobile device can remain lightweight and low cost, but the module can be used to improve reliability and accessibility.

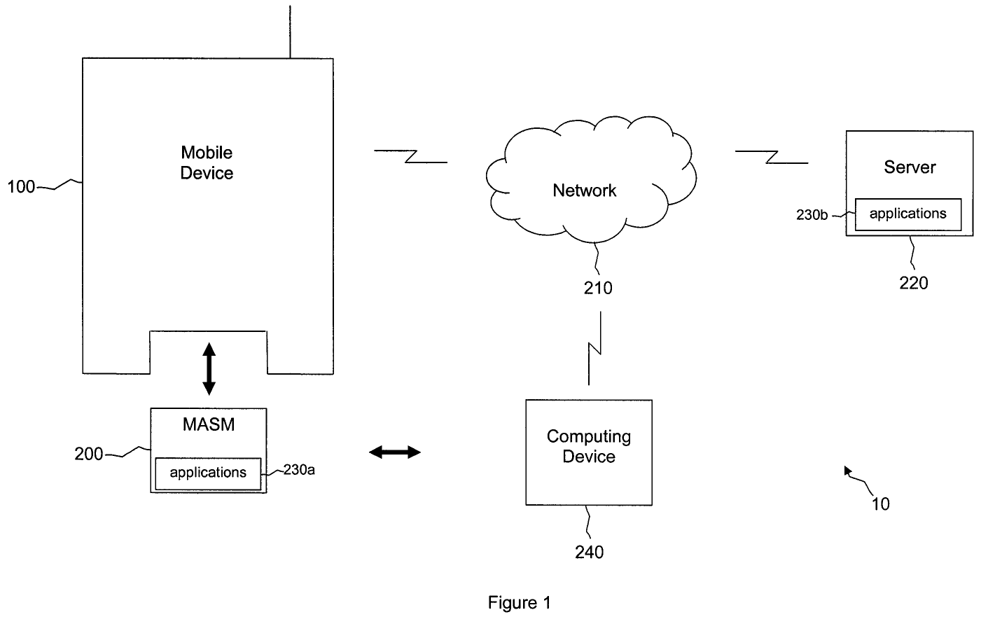

FIG. 1 illustrates an embodiment of a system 10 that allows either local or remote execution of a WebOS-based application. The system 10 includes a mobile device 100 that can communicate wirelessly with a telecommunications network 210. A server 220 can also communicate wirelessly with the telecommunications network 210. A browser or similar graphical user interface on the mobile device 100 can be used to interact with the network 210 and thereby launch one or more applications 230b on the server 220. The server 220 can execute the applications 230b on behalf of the mobile device 100 and return the results of the execution to the mobile device 100 via the network 210.

A removable mobile application server module (MASM) 200 can be modularly coupled to and uncoupled from the mobile device 100 using well known techniques such as by tension, spring, latch, or other known assemblies to promote quick and easy attachment and detachment or removal. A connection port on the MASM 200 might connect to a connection port on the mobile device 100 or a cable or other intermediary device might connect the MASM 200 to the mobile device 100. Alternatively, a Bluetooth connection or other wireless connection might be used to transfer data between the MASM 200 and the mobile device 100. A wireless connection might allow a user of the mobile device 100 to store the MASM 200 in a location, such as a briefcase, backpack, or pocket, remote from the mobile device 100 while still allowing connectivity between the mobile device 100 and the MASM 200.

The MASM 200 can contain one or more applications 230a that are executable by the MASM 200 when the MASM 200 is coupled to the mobile device 100. One or more of the applications 230a are also executable by the server 220. That is, there is at least one application 230 that is present on both the MASM 200 and the server 220. When the MASM 200 is coupled to the mobile device 100, this common application 230 might be executed by the MASM 200 and when the MASM 200 is not coupled to the mobile device 100, the common application 230 might be executed by the server 220. In either case, the results of the execution are provided to the mobile device 100.

The applications 230 might be any applications typically installed on mobile devices 100 such as email applications, calendars, address books, calculators, games, word processing applications, spreadsheet applications, database applications, presentation applications, business-related applications, and other applications. Since the applications 230 are not stored on the mobile device 100, the mobile device 100 can be considered a thin client.

When one of the applications 230b on the server 220 is also present as one of the applications 230a on the MASM 200, the application 230a and the application 230b are not necessarily identical. The common application 230 that is stored in the two different locations might actually be two different instances or two different versions of the same application 230 or there might be other minor differences between the application 230a on the MASM 200 and the application 230b on the server 220. For example, a full-featured version of the application 230b might be stored on the server 220 and a scaled-down version of the application 230b might be stored on the MASM 200.

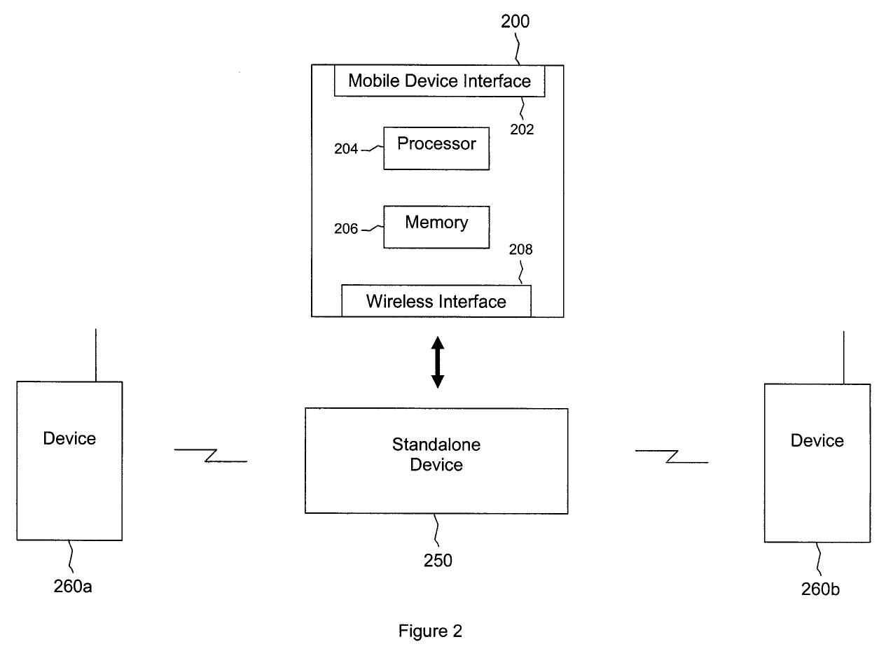

FIG. 2 includes a block diagram of an embodiment of the MASM 200. A mobile device interface 202 allows the MASM 200 to couple to the mobile device 100. The mobile device interface 202 might be a serial port, a Universal Serial Bus (USB) port, a Bluetooth or other wireless connection, or another interface well known to those of skill in the art. A processor 204 executes the applications 230a that are stored on the MASM 200. A memory 206 stores the applications 230a. Having only this minimal set of components allows the MASM 200 to have a small size that promotes easy portability for the MASM 200 and for the mobile device 100 when the MASM 200 is coupled to the mobile device 100. In this embodiment, the MASM 200 does not include an integral or on-board power source but instead derives its power from the mobile device 100 or other device to which it might be coupled.

A mobile device user might customize the MASM 200 by loading one or more preferred applications 230a into the memory 206 of the MASM 200. The applications 230a could be downloaded from the server 220 via the mobile device 100, could be downloaded from other sources, or could be loaded onto the MASM 200 in other manners. When the user wishes to launch one of the preferred applications 230a, the application 230a could execute on the MASM 200 and a connection between the mobile device 100 and the server 220 would not be necessary. Other applications 230b that the user does not use often might reside on the server 220 but not on the MASM 200 and could still be accessed over the network 210.

Use of the MASM 200 can allow reliable and flexible execution of the WebOS-based applications 230. A mobile device user does not need to rely on a connection to the server 220 in order to launch one of the applications 230a on the MASM 200. Yet, the user need not load large numbers of applications 230a on the MASM 200 since rarely used applications 230b could be stored and executed on the server 220. It should be understood that the presence of one of the applications 230 on the MASM 200 does not preclude the execution of that application 230 on the server 220. That is, a user might choose to launch one of the applications 230 on the server 220 in the standard WebOS manner even when a version of the same application 230 is loaded onto the MASM 200.

When one of the applications 230 is present on both the MASM 200 and the server 220, the user might be able to switch execution of the application 230 between the MASM 200 and the server 220. For example, the user might choose to execute the application 230 on the server 220 when a connection to the server 220 is available. If the user then moved to an area where the connection to the server 220 is unreliable, execution of the application 230 might be switched, automatically or selectively by the user, to the MASM 200. Transitions between execution by the server 220 and execution by the MASM 200 might be done in such a manner that the user is not aware of any disruption in the functionality provided by the application 230. For example, the user might not be allowed to remove the MASM 200 from the mobile device 100 until execution of one of the applications 230 has transferred to the server 220.

When one of the applications 230 is executing on either the MASM 200 or the server 220, the application 230 might modify data that is stored on the server 220 or in the memory 206 of the MASM 200. When a transition occurs between execution on the MASM 200 and execution on the server 220, it would typically be desirable that the data in the two locations be synchronized. In an embodiment, when execution of the application 230 transfers from the MASM 200 to the server 220 or from the server 220 to the MASM 200, application-related data is also transferred from the MASM 200 to the server 220 or from the server 220 to the MASM 200.

The use of the MASM 200 in conjunction with the mobile device 100 can allow a single, low-cost model of the mobile device 100 to be manufactured. The single model of the mobile device 100 could then be used in different circumstances depending on whether the MASM 200 were coupled to the mobile device 100 and which applications 230a were loaded onto the MASM 200. A user who wished to purchase a low-cost mobile device mobile device 100 could forego the purchase of the MASM 200 and use the mobile device 100 to execute only the applications 230b on the server 220. A user who wished to have more reliable service might purchase the MASM 200, load one or more applications 230a onto the MASM 200, and execute the applications 230a on the MASM 200.

In an embodiment, the MASM 200 might be shared by several users. For example, a household, a company, a department within a company, or some other group might have a greater number of mobile devices 100 than MASMs 200. Under most circumstances, members of the group might use the low-cost mobile devices 100 without the MASMs 200 and connect wirelessly to the server 220 to access the applications 230b on the server 220. In other circumstances, one or more of the members of the group might couple one of the shared MASMs 200 to one of the mobile devices 100 and access the applications 230a on the MASM 200. For instance, if one of the group members traveled to an area where the wireless telecommunications connections are unreliable or non-existent, that group member might temporarily couple one of the MASMs 200 to one of the mobile devices 100 to ensure that access to the applications 230a on the MASM 200 could be maintained. The group member might then return the MASM 200 to a pool of MASMs 200 upon returning from the trip.

In other embodiments, devices other than the mobile device 100 to which the MASM 200 is coupled might have access to the applications 230a on the MASM 200. That is, the MASM 200 might act as an application server to other devices. In one example of these embodiments, a mobile telecommunications-capable device similar to the mobile device 100 might establish a wireless telecommunications connection with the mobile device 100 and, via the wireless connection, gain access to the applications 230a on the MASM 200 that is coupled to the mobile device 100.

In another example of these embodiments, the MASM 200 could be coupled to a desktop computer, laptop computer, or similar computing device. This is illustrated in FIG. 1, where the MASM 200 is couplable to a computing device 240. The computing device 240 might gain access to the applications 230a on the MASM 200 through a direct or indirect connection between the computing device 240 and the MASM 200. Alternatively or additionally, when the MASM 200 is coupled to the computing device 240, the computing device 240 might be capable of establishing a wireless data communication connection with other computing devices, with one or more mobile devices 100, or with other devices. These other devices might then gain access to the applications 230a on the MASM 200 through the wireless connection with the computing device 240.

Another example of these embodiments is illustrated in FIG. 2. In this case, the MASM 200 is couplable to a standalone device 250 that promotes the connection of other devices 260 to the MASM 200. The other devices 260 might be computing devices 240, mobile devices 100, or other types of devices. Although two other devices 260 are shown in FIG. 2, in other embodiments other numbers of other devices 260 could be present.

In one instance, the standalone device 250 might be capable of establishing a wireless data communication connection with the other devices 260. The other devices 260 might then gain access to the applications 230a on the MASM 200 through the wireless connection with the standalone device 250. In this case, the MASM 200 might be a passive device, as previously discussed, that merely allows the standalone device 250 access to the applications 230a and, as such, the standalone device 250 might handle the wireless communication functions. In another instance, the MASM 200 might be an active device that is capable of establishing a wireless data communication connection with the other devices 260. The other devices 260 might then gain access to the applications 230a on the MASM 200 through the wireless connection with the MASM 200. In this case, the standalone device 250 might merely provide power to the MASM 200.

In the embodiment of FIG. 2, the MASM 200 is an active device capable of establishing wireless data communications with the other devices 260. Therefore, the MASM 200 includes a wireless interface 208 for promoting wireless communication. The wireless interface 208 might establish wireless communication via, for example, radio frequency, WiFi, Code Division Multiple Access (CDMA), Global System for Mobile Communications (GSM), or other well known wireless communication technologies. In other embodiments, the MASM 200 might be a passive device that relies on the standalone device 250 to which it is coupled to establish wireless data communication with the other devices 260. In such cases, the wireless interface 208 would not be present.

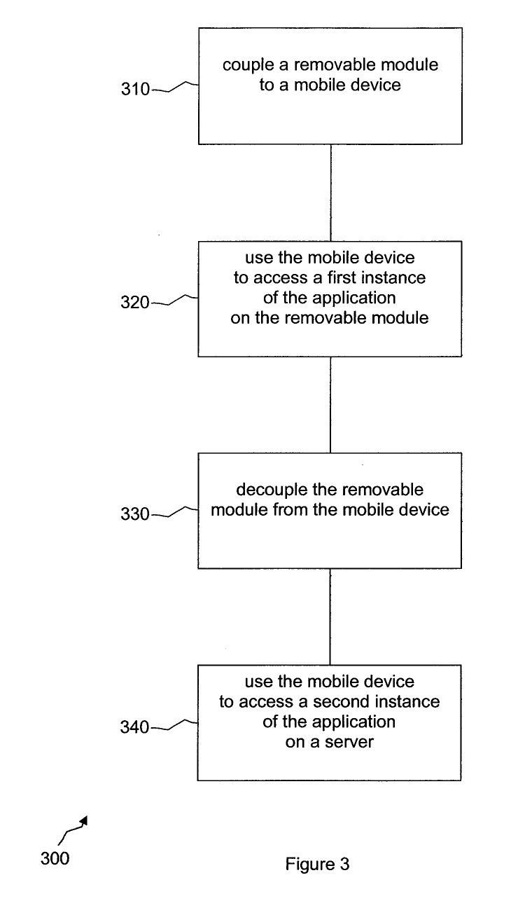

FIG. 3 illustrates a method 300 for promoting execution of an application. In box 310, a removable module containing the application is coupled to a mobile device. In box 320, the mobile device is used to access a first instance of the application on the removable module. In box 330, the removable module is decoupled from the mobile device. In box 340, the mobile device is used to access a second instance of the application on a server that is connected wirelessly to the mobile device.

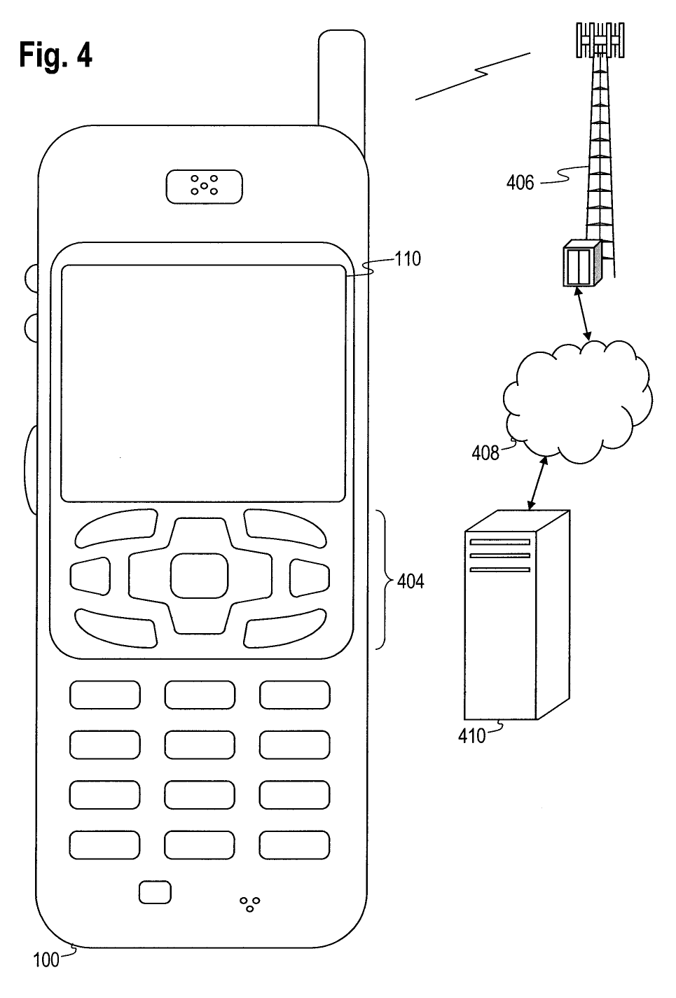

FIG. 4 shows a wireless communications system including the mobile device 100. The mobile device 100 is operable for implementing aspects of the disclosure, but the disclosure should not be limited to these implementations. Though illustrated as a mobile phone, the mobile device 100 may take various forms including a wireless handset, a pager, a personal digital assistant (PDA), a portable computer, a tablet computer, or a laptop computer. Many suitable mobile devices combine some or all of these functions. In some embodiments of the disclosure, the mobile device 100 is not a general purpose computing device like a portable, laptop or tablet computer, but rather is a special-purpose communications device such as a mobile phone, wireless handset, pager, or PDA.

The mobile device 100 includes a display 110 and a touch-sensitive surface or keys 404 for input by a user. The mobile device 100 may present options for the user to select, controls for the user to actuate, and/or cursors or other indicators for the user to direct. The mobile device 100 may further accept data entry from the user, including numbers to dial or various parameter values for configuring the operation of the mobile device 100. The mobile device 100 may further execute one or more software or firmware applications in response to user commands. These applications may configure the mobile device 100 to perform various customized functions in response to user interaction.

Among the various applications executable by the mobile device 100 are a web browser, which enables the display 110 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the mobile device 100 has access to information on various servers, such as a server 410. The server 410 may provide content that may be shown on the display 110.

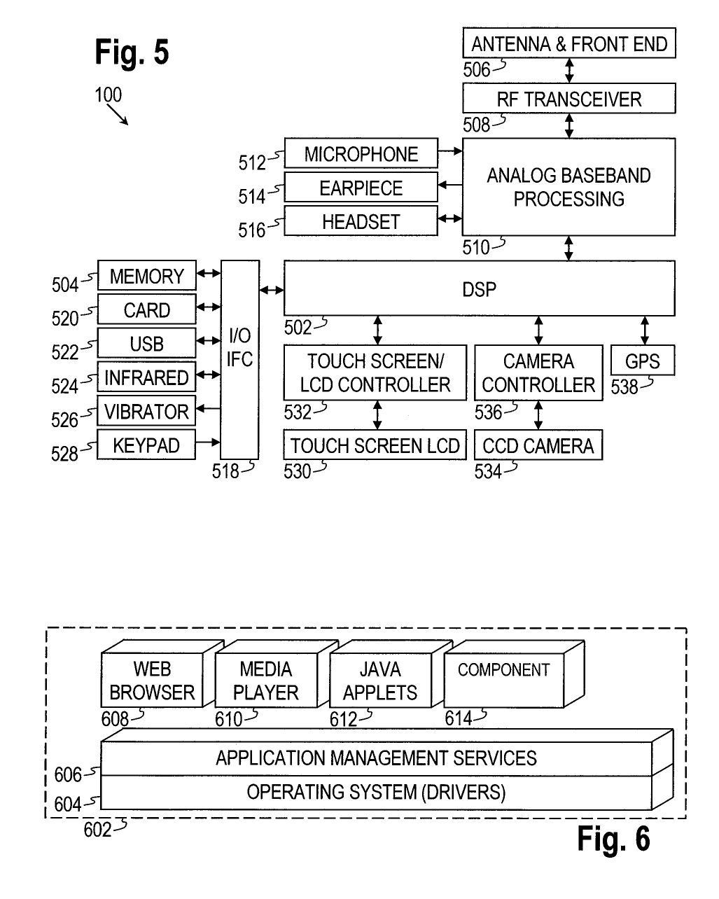

FIG. 5 shows a block diagram of the mobile device 100. The mobile device 100 includes a digital signal processor (DSP) 502 and a memory 504. As shown, the mobile device 100 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the mobile device 100 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the mobile device 100 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the mobile device 100 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the mobile device 100 to function as a peripheral device to exchange information with a personal computer or other computer system. The infrared port 524 and other optional ports such as a Bluetooth interface or an IEEE 802.11 compliant wireless interface may enable the mobile device 100 to communicate wirelessly with other nearby mobile devices and/or wireless base stations.

The input/output interface 518 may further connect the DSP 502 to the vibrator 526 that, when triggered, causes the mobile device 100 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the mobile device 100. Another input mechanism may be the touch screen LCD 530, which may also display text and/or graphics to the user. The touch screen LCD controller 532 couples the DSP 502 to the touch screen LCD 530.

The CCD camera 534 enables the mobile device 100 to take digital pictures. The DSP 502 communicates with the CCD camera 534 via the camera controller 536. The GPS sensor 538 is coupled to the DSP 502 to decode global positioning system signals, thereby enabling the mobile device 100 to determine its position. Various other peripherals may also be included to provide additional functions, e.g., radio and television reception.

FIG. 6 illustrates a software environment 602 that may be implemented by the DSP 502. The DSP 502 executes operating system drivers 604 that provide a platform from which the rest of the software operates. The operating system drivers 604 provide drivers for the mobile device hardware with standardized interfaces that are accessible to application software. The operating system drivers 604 include application management services (“AMS”) 606 that transfer control between applications running on the mobile device 100. Also shown in FIG. 6 are a web browser application 608, a media player application 610, and Java applets 612. The web browser application 608 configures the mobile device 100 to operate as a web browser, allowing a user to enter information into forms and select links to retrieve and view web pages. The media player application 610 configures the mobile device 100 to retrieve and play audio or audiovisual media. The Java applets 612 configure the mobile device 100 to provide games, utilities, and other functionality. A component 614 might provide functionality related to the MASM 200.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for executing an application, comprising:
a mobile device;
a module to store the application and operable to be coupled to communicate to and decoupled from the mobile device; and
a server operable to store the application and to wirelessly communicate with the mobile device via a network and operable to provide the mobile device access to the application on the server such that the mobile device is operable to access the application via the module when the module is coupled to communicate with the mobile device and when the mobile device is decoupled from the module, the mobile device is operable to access the application via the server.

2. The system of claim 1, wherein, when a user of the mobile device is using the application, the execution of the application is not substantially disrupted when the execution transfers between the module and the server.

3. The system of claim 1, wherein the application is locally manipulable on the mobile device but executable on the server.

4. The system of claim 1, wherein the application is locally manipulable on the mobile device but executable on the module.

5. The system of claim 1, wherein the application is a WebOS application.

6. The system of claim 1, wherein the module is operable to be coupled to and decoupled from a computing device and is further operable to promote the application being accessible by the computing device.

7. The system of claim 6, wherein the module is operable to execute the application on behalf of a device wirelessly connected to the computing device.

8. The system of claim 1, wherein the application is not stored on the mobile device.

9. The system of claim 8, wherein the application is one of an email application, a calendar, an address book, a calculator, a game, a word processing application, a spreadsheet application, a database application, a presentation application, and a business-related application.

10. The system of claim 1, wherein the module is coupled to communicate to the mobile device via one of a serial connection, a USB connection, and a wireless connection.

11. The system of claim 1, wherein the mobile device is operable to access the application on the server when the module is coupled to the mobile device.

12. The system of claim 1, wherein the module is operable to be coupled to and decoupled from a standalone device and the module is further operable to execute the application on behalf of a device wirelessly connected to the standalone device.

13. The system of claim 1, wherein the module further comprises a component operable to establish a wireless connection to a device and the module is further operable to execute the application on behalf of the device when the module is wirelessly connected to the device and the module is further operable to couple to a standalone device that provides power to the module.

14. A method to promote execution of an application, comprising:
coupling a removable module to a mobile device;
using the mobile device to access a first instance of the application on the removable module;
decoupling the removable module from the mobile device; and
using the mobile device to access a second instance of the application on a server so that the mobile device is used to locally manipulate the application and the application executes on the server.

15. A mobile device for accessing an application, comprising:
an interface operable to promote coupling the mobile device to a removable module, the removable module operable to store the application and operable to be coupled to communicate to and decoupled from the mobile device; and
a component operable to wirelessly connect the mobile device to a server via a network, the server operable to provide access to the application stored on the server by the mobile device such that the mobile device is operable to access the application via the removable module when the removable module is coupled to communicate with the mobile device and when the mobile device is decoupled from the removable module, the mobile device is operable to access the application via the server.

16. The mobile device of claim 15, wherein the application is locally manipulable on the mobile device but executable on at least one of the server and the removable module.

17. The mobile device of claim 15, wherein the application is a WebOS application.

18. The mobile device of claim 15, wherein the removable module is operable to be coupled to and decoupled from a computing device and is further operable to promote the application being accessible by the computing device.

19. The mobile device of claim 18, wherein the removable module is operable to execute the application on behalf of a device wirelessly connected to the computing device.

20. The mobile device of claim 15, wherein the removable module obtains power from the mobile device.
